(19) United States
(12) Patent Application Publication
(10) Pub. No.: US 2025/0115253 A1
(43) Pub. Date: Apr. 10, 2025

(54) METHODS AND SYSTEMS FOR TRAJECTORY PREDICTION

(71) Applicant: HUAWEI TECHNOLOGIES CO., LTD., Shenzhen (CN)

(72) Inventors: Mozhgan POURKESHAVARZ, Richmond Hill (CA); Amir RASOULI, Etobicoke (CA)

(21) Appl. No.: 18/482,425

(22) Filed: Oct. 6, 2023

(51) Int. Cl. B60W 50/00; B60W 60/00; G06N 3/0895

(52) U.S. Cl. CPC B60W 50/0097; B60W 60/001; G06N 3/0895; B60W 2050/0022; B60W 2552/10; B60W 2556/40

(57) ABSTRACT

Computerized systems and methods for training a trajectory prediction model for autonomous driving vehicles. The systems and methods receive agent dynamics data, high-dimensional (HD) map data; a training data set; and a plurality of meta paths through the HIN representing lane transitions, each meta path comprising a sequence of lane nodes and edges. Scene encoding is performed on the agent dynamics data and the HD map data to produce a directed Heterogeneous Information Network (HIN) as a graph comprising nodes and edges. The trajectory prediction model is trained based on a comparison between a prediction, by the trajectory prediction model, of a positive or negative presence of the meta paths between nodes and meta path ground truth obtained from the training data set and between motion trajectory predictions, by the trajectory prediction model, and motion trajectory ground truth obtained from the training data set.

### FIELD

The present technology relates broadly to trajectory prediction in motion planning applications; and more specifically, to methods and systems for trajectory prediction in autonomous vehicle applications.

### BACKGROUND

Vehicle trajectory prediction is one of the building blocks of autonomous driving systems. Prediction demonstrates how the future might unfold based on the road structure and the behavior of road users. To operate, self-driving cars aim to accurately perceive the geometric and semantic information in a driving scene captured by a perception system and to predict diverse, yet scene-compliant, trajectories for moving agents in the driving scene. High-Definition (HD) maps provide useful cues since the behaviors of agents and the interactions among them are largely influenced by the road topology and are governed by the map constraints. For example, a vehicle is unlikely to change to a lane that runs in the opposite direction. In this light, the structure of the map provides important learning for a trajectory prediction module to predict a variety of feasible trajectories.

Some attempts to integrate the structural nature of the road in trajectory prediction involve map vectorization in which lanes are converted into vectors. For example, in the paper “VectorNet: Encoding HD Maps and Agent Dynamics from Vectorized Representation” (Jiyang Gao, Chen Sun, Hang Zhao, Yi Shen, Dragomir Anguelov, Congcong Li, Cordelia Schmid) published 8 May 2020, the authors propose to vectorize HD maps and agent trajectories and to treat each vector point as a node in a graph. Features of the node include start and end locations along with semantic labels. The context information from HD maps and trajectories of moving agents are propagated through a Graph Neural Network (GNN) having output node features that can be decoded to obtain future trajectories for the various agents.

In the publication “Learning Lane Graph Representations for Motion Forecasting” (Ming Liang, Bin Yang, Rui Hu, Yun Chen, Renjie Liao, Song Feng, Raquel Urtasun) published 27 July 202, a motion forecasting model is described that exploits a structured map representation as well as actor-map interactions. A lane graph is constructed from vectorized map data to explicitly preserve the map structure. A Graph Convolutional Network (GCN) embodies a motion forecasting model that represents both agents and lanes as nodes in the graph and extracts features for the agents and lane nodes. Four types of interactions are modeled including agent-to-lane, lane-to-lane, lane-to-actor and actor-to-actor. A prediction header predicts a plurality of motion trajectories for the agents along with associated confidence scores.

Such graph structures can be leveraged to learn the relationships between vectorized entities. In this way, connected lanes in various formations, e.g. successor, predecessor, right, and left, represent admissible ways to traverse the road topology. The HD map lane graph has edges with different semantic meanings, indicating its heterogeneous nature. Although existing lane graphs are shown to be effective in learning local structures through the adjacent lanes, they may not be able to effectively model more complex patterns imposed by long-range heterogeneous connections between nonadjacent, yet interacting, lanes. These connections are important to capture high-level intentions, such as overtaking, merging, and double turns, and can potentially represent the constraints and rules of the road.

Accordingly, predicting diverse yet admissible trajectories that adhere to the map constraints is challenging. Graph-based scene encoders are effective for preserving the local structures of the maps by defining lane-level connections. However, such encoders do not capture more complex patterns emerging from long-range heterogeneous connections between nonadjacent interacting lanes, for example, a merge pattern in the road structure that involves both lateral and sequential relations.

It is desirable to provide a framework to provide systems and methods for trajectory prediction that consider high-order combinations of basic adjacent-adjacent patterns as the full gamut of lane interactions when predicting vehicle trajectories. It is further desirable for such systems and methods to learn existing patterns of the road topology which are representing the patterns of traveling through the road so that a motion prediction model can predict scene-compliant trajectories. Furthermore, other desirable features and characteristics of the present disclosure will become apparent from the subsequent detailed description and the appended claims, taken in conjunction with the accompanying drawings and the foregoing technical field and background.

### SUMMARY

It is an object of the present technology to ameliorate at least one inconvenience associated with the prior art.

Embodiments of the present technology address the aforementioned challenges by introducing a MEta-road NeTwORk (MENTOR) to learn meta-road paths. Specifically, a self-supervised task is introduced for trajectory prediction to formulate traffic patterns imposed by road constraints. In particular, a lane meta path is utilized in training a motion prediction model. The lane meta path is a composite relation of heterogeneous edges in a scene graph that can model diverse abstractions from a HD map without additional data and labels. Therefore, by predicting the presence of predefined lane meta paths in a driving scene as self-supervised learning task, the motion prediction model gets a sense of feasible transitions on the map as navigation tips for traversing the road. Furthermore, a trajectory prediction framework is described herein that provides insight into the structural perspective of the map by simultaneously predicting a set of auxiliary tasks that test the connectivity of the lane-meta paths between nodes during training. The presently disclosed framework thus learns to learn road topology by automatically selecting the auxiliary tasks that assist the primary task of target agent trajectory prediction.

The incorporation of lane meta paths into training the motion prediction model allows modeling long-range connectivity within the map using structural graph characteristics, thus embedding existing constraints in the map. Further, the use of self-supervised learning means that there is no requirement for manual labeling or extra data. The self-supervised learning approach described herein enables the model to identify an effective combination of auxiliary tasks and to automatically balance them to improve the primary task of motion prediction.

In a first aspect, there is provided a computerized method of training a trajectory prediction model for autonomous driving vehicles. The method comprises receiving agent dynamics data, receiving high-dimensional (HD) map data, receiving a plurality of meta paths through the HIN representing lane transitions, each meta path comprising a sequence of lane nodes and edges, and receiving a plurality of meta paths through the HIN representing lane transitions, each meta path comprising a sequence of lane nodes and edges. The method includes performing scene encoding on the agent dynamics data and the HD map data to produce a directed Heterogeneous Information Network (HIN) as a graph comprising nodes and edges, wherein there is a plurality of node types including lane nodes and agent nodes and a plurality of edge types. The method includes training the trajectory prediction model based on a comparison between a prediction, by the trajectory prediction model, of a positive or negative presence of the meta paths between nodes and meta path ground truth obtained from the training data set and between motion trajectory predictions, by the trajectory prediction model, and motion trajectory ground truth obtained from the training data set, and storing the trajectory prediction model on computer memory for use in trajectory prediction for autonomous vehicles.

In embodiments, the trajectory prediction model is a Graph Neural Network.

In embodiments, training the trajectory prediction model comprises meta path self-supervised learning having trajectory prediction as a primary task and predicting presence of meta paths between nodes as auxiliary tasks.

In embodiments, the primary task and the auxiliary tasks share model parameters and each of the primary and auxiliary tasks have a task specific parameter in an objective function that is minimized in training the trajectory prediction model.

In embodiments, the method includes parametrizing the model parameters using a weighting function that is learned during training.

In embodiments, the comparison between the prediction, by the trajectory prediction model, of the positive or negative presence of the meta paths between nodes and the meta path ground truth obtained from the training data set and between the motion trajectory predictions, by the trajectory prediction model, and the motion trajectory ground truth from the training data set comprises calculating loss values for each of the plurality of meta paths and for the motion trajectory predictions.

In embodiments, the edge types comprise at least two of: agents to lanes, lanes to lanes, lanes to agents and agents to agents, successor node, predecessor node, left node and right node.

In embodiments, training the trajectory prediction model comprises predicting, by the trajectory prediction model, the positive or negative presence of the meta paths between a plurality of arbitrary nodes, wherein the meta path represents common driving lane transitions by agents.

In embodiments, predicting, by the trajectory prediction model, the positive or negative presence of the meta paths between nodes is performed as a link prediction task.

In embodiments, the meta path ground truth is, at least in part, algorithmically determined by traversing the meta path between nodes in the directed HIN.

In embodiments, positive and negative samples are provided for each meta path during training the trajectory prediction model.

In embodiments, training the trajectory prediction model based on the comparison between the prediction, by the trajectory prediction model, of the positive or negative presence of the meta paths between nodes comprises selecting a start node within a local boundary of an agent and selecting an end nodes at a predefined number of successive nodes away from the agent and assessing the positive or negative presence of the meta paths against the start and end nodes.

In embodiments, the meta paths have a length of between 4 and 7 successive lane nodes and include at least one left or right transition.

In embodiments, the plurality of meta paths comprises at least 4 different meta paths.

In another aspect, a system is provided comprising: at least one processor, and at least one memory comprising executable instructions that, when executed by the at least one processor, cause the system to: receive agent dynamics data, receive high-dimensional (HD) map data, perform scene encoding on the agent dynamics data and the HD map data to produce a directed Heterogeneous Information Network (HIN) as a graph comprising nodes and edges, wherein there is a plurality of node types including lane nodes and agent nodes and a plurality of edge types, receive a plurality of meta paths through the HIN representing lane transitions, each meta path comprising a sequence of lane nodes and edges, and receive a training data set. The processor is configured to train the trajectory prediction model based on a comparison between a prediction, by the trajectory prediction model, of a positive or negative presence of the meta paths between nodes and meta path ground truth obtained from the training data set and between motion trajectory predictions, by the trajectory prediction model, and motion trajectory ground truth obtained from the training data set, and store the trajectory prediction model on computer memory for use in trajectory prediction for autonomous vehicles.

In embodiments, the trajectory prediction model is a Graph Neural Network.

In embodiments, training the trajectory prediction model comprises meta path self-supervised learning having trajectory prediction as a primary task and predicting presence of meta paths between nodes as auxiliary tasks.

In embodiments, a weight network is trained during training the trajectory prediction model with weights for the auxiliary tasks learned with the objective of optimizing the primary task.

In embodiments, predicting, by the trajectory prediction model, the positive or negative presence of the meta paths between nodes is performed as a link prediction task, and wherein the meta path ground truth is, at least in part, algorithmically determined by traversing the meta path between nodes in the HIN.

In a further aspect, an autonomous vehicle is provided. The autonomous vehicle comprises a perception system for providing perception data of a driving scene and a motion planning system. The motion planning system includes at least one processor, and at least one memory comprising executable instructions that, when executed by the at least one processor, cause the motion planning system to: determine agent dynamics data for agents in the driving scene based on the perception data, retrieve high-dimensional (HD) map data, perform scene encoding on the agent dynamics data and the HD map data to produce a directed Heterogeneous Information Network (HIN) as a graph comprising nodes and edges, wherein there is a plurality of node types including lane nodes and agent nodes and a plurality of edge types, receive a plurality of meta paths through the HIN representing lane transitions, each meta path comprising a sequence of lane nodes and edges, and process the meta paths and the HIN using a trajectory prediction model to predict at least one trajectory for the agents in the driving scene. An autonomous vehicle driving system is provided to control driving of the autonomous vehicle based on the at least one trajectory.

In embodiments, the motion prediction model is trained according the training methods and systems described herein.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “user device” is any computer hardware that is capable of running software appropriate to the relevant task at hand. Thus, some (non-limiting) examples of user devices include personal computers (desktops, laptops, netbooks, etc.), smartphones, and tablets, as well as network equipment such as routers, switches, and gateways. It should be noted that a device acting as a user device in the present context is not precluded from acting as a server to other user devices. The use of the expression “a user device” does not preclude multiple user devices being used in receiving/sending, carrying out or causing to be carried out any task or request, or the consequences of any task or request, or steps of any method described herein. It is contemplated that the user device and the server can be implemented as a same single entity.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context), firmware, hardware, or a combination thereof, that is both necessary and sufficient to achieve the specific function(s) being referenced.

In the context of the present specification, the expression “computer usable information storage medium” or “computer-readable medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a computer system that can be used for implementing certain non-limiting embodiments of the present technology;

FIG. 2 depicts a schematic diagram of an autonomous driving system associated with a vehicle, in accordance with certain non-limiting embodiments of the present technology;

FIG. 3 depicts a schematic diagram of a trajectory prediction training system, in accordance with certain non-limiting embodiments of the present technology;

FIG. 4 depicts a schematic diagram of graph representation of driving scenes and an exemplary meta path, in accordance with certain non-limiting embodiments of the present technology; and

FIG. 5 depicts a flowchart diagram of a method a training method for training a trajectory prediction model, in accordance with certain non-limiting embodiments of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagram herein represents conceptual views of illustrative circuitry embodying the principles of the present technology. Similarly, it will be appreciated that any flowcharts, flow diagrams, state transition diagrams, pseudo-code, and the like represent various processes that may be substantially represented in non-transitory computer-readable media and so executed by a computer or processor, whether or not such computer or processor is explicitly shown.

The functions of the various elements shown in the figures, including any functional block labelled as a “processor” or “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

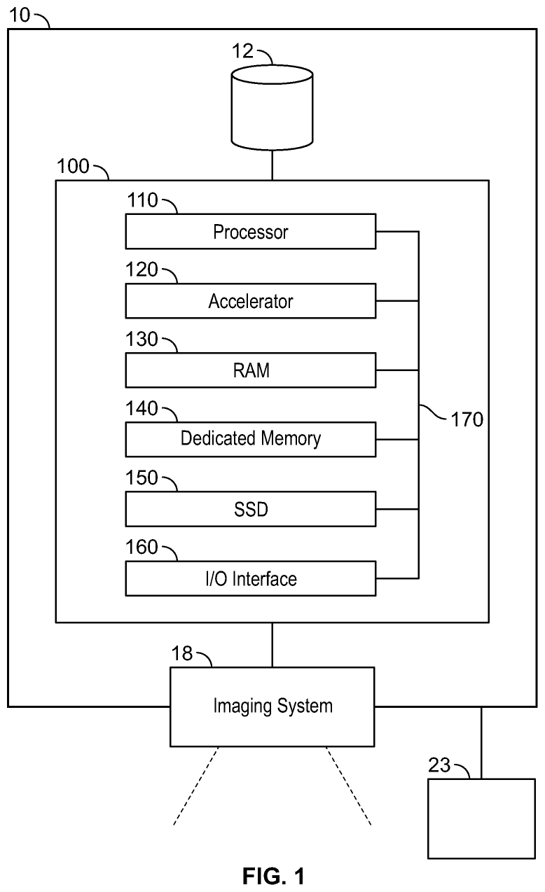

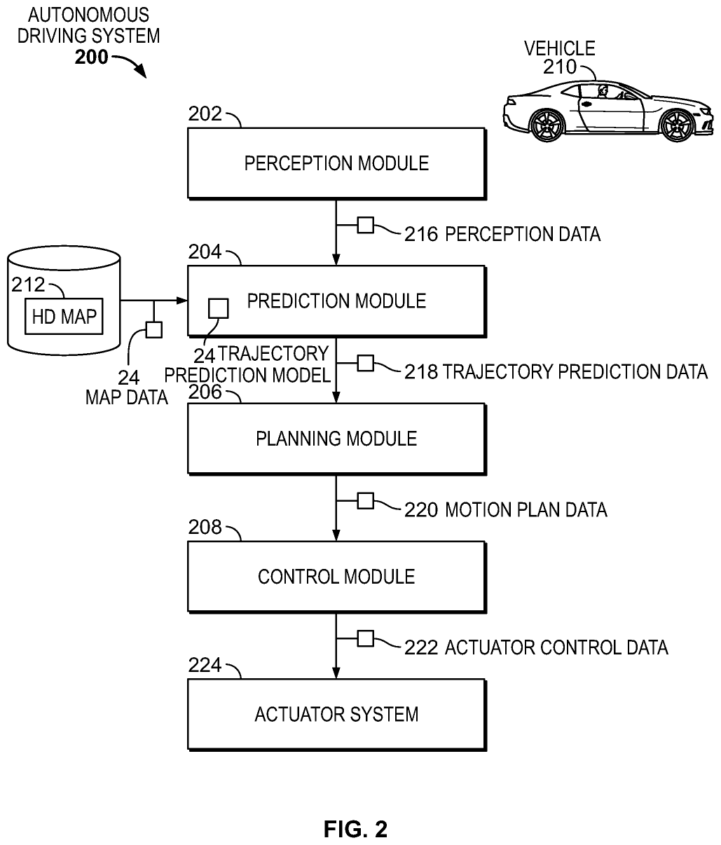

With reference to FIG. 1, there is depicted a schematic diagram of a computer system 10 configured for training a trajectory prediction model and for processing a driving scene to predict agent trajectories using the trajectory prediction model. The computer system 10 comprises a computing unit 100 that may receive perception data 216 (see FIG. 2) representing a driving scene and is configured to generate a graph representation of the driving scene, to process the graph representation with the trajectory prediction model with additional processing of meta paths connecting a plurality of successive nodes in the graph representation and to generate predicted trajectories for agents in the driving scene. During training, training data for ground truth of trajectory predictions is provided and training data for ground truth of meta path predictions is provided in a self-supervised learning approach. It should be appreciated that the computing unit 100 at run-time and that for training may not be the same computing unit 100 although many of the functional units described in the following will be present in a training and run-time computing unit 100. The computing unit 100 is described in greater details hereinbelow.

In some non-limiting embodiments of the present technology, the computing unit 100 may be implemented by any of a conventional personal computer, a controller, and/or an electronic device (e.g., a server, a controller unit, a control device, a monitoring device, a personal computer, a laptop, a tablet, etc.) and/or any combination thereof appropriate to the relevant task at hand. In some non-limiting embodiments of the present technology, the computing unit 100 comprises various hardware components including one or more single or multi-core processors collectively represented by a processor 110, a solid-state drive 150, a random access memory (RAM) 130, a dedicated memory 140 and an input/output interface 160. In some non-limiting embodiments of the present technology, the computing unit 100 may be a computer specifically designed to train and/or execute a machine learning algorithm (MLA) and/or deep learning algorithms (DLA). The computing unit 100 may be a generic computer system.

In some other non-limiting embodiments of the present technology, the computing unit 100 may be an “off-the-shelf” generic computer system. In some non-limiting embodiments of the present technology, the computing unit 100 may also be distributed amongst multiple systems (such as electronic devices or servers). The computing unit 100 may also be specifically dedicated to the implementation of the present technology. Other variations as to how the computing unit 100 can be implemented are envisioned without departing from the scope of the present technology.

Communication between the various components of the computing unit 100 may be enabled by one or more internal and/or external buses 170 (e.g. a PCI bus, universal serial bus, IEEE 1394 “Firewire” bus, SCSI bus, Serial-ATA bus, ARINC bus, etc.), to which the various hardware components are electronically coupled.

The input/output interface 160 may provide networking capabilities such as wired or wireless access. As an example, the input/output interface 160 may comprise a networking interface such as, but not limited to, one or more network ports, one or more network sockets, one or more network interface controllers and the like. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to certain non-limiting embodiments of the present technology, the solid-state drive 120 stores program instructions suitable for being loaded into the RAM 130 and executed by the processor 110. Although illustrated as the solid-state drive 150, any type of memory may be used in place of the solid-state drive 150, such as a hard disk, optical disk, and/or removable storage media. According to implementations of the present technology, the solid-state drive 120 stores program instructions suitable for being loaded into the RAM 130 and executed by the processor 110 for performing the methods and function described herein with respect the use of meta paths in processing a driving scene for trajectory prediction and also in training a trajectory prediction model. For example, the program instructions may be part of a library or an application.

The processor 110 may be a general-purpose processor, such as a central processing unit (CPU) or a processor dedicated to a specific purpose, such as a digital signal processor (DSP). In some non-limiting embodiments, the processor 110 may also rely on an accelerator 120 dedicated to certain given tasks, such as executing the methods set forth in the paragraphs below. In some embodiments, the processor 110 or the accelerator 120 may be implemented as one or more field programmable gate arrays (FPGAs). Moreover, explicit use of the term “processor”, should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

Further, in certain non-limiting embodiments of the present technology, the computer system 10 comprises an imaging system 18 that may be configured to capture Red-Green-Blue (RGB) images or a series thereof. The imaging system 18 may comprise camera sensors such as, but not limited to, Charge-Coupled Device (CCD) or Complementary Metal Oxide Semiconductor (CMOS) sensors and/or digital cameras.

Further, according to certain non-limiting embodiments of the present technology, the imaging system 18 may be configured to convert an optical image into an electronic or digital image and may send captured images to the computing unit 100. In some non-limiting embodiments of the present technology, the imaging system 18 may be a single-lens camera providing RGB pictures. In these embodiments, the imaging system 18 can be implemented as a camera of a type available from FLIR INTEGRATED IMAGING SOLUTIONS INC., 12051 Riverside Way, Richmond, BC, V6W 1K7, Canada. It should be expressly understood that the single-lens camera can be implemented in any other suitable equipment.

Further, in other non-limiting embodiments of the present technology, the imaging system 18 comprises depth sensors configured to acquire RGB-Depth (RGBD) pictures. In yet other non-limiting embodiments of the present technology, the imaging system 18 can include a LiDAR system configured for gathering information about surroundings of the computer system 10 or another system and/or object to which the computer system 10 is coupled. It is expected that a person skilled in the art would understand the functionality of the LiDAR system, but briefly speaking, a light source of the LiDAR system is configured to send out light beams that, after having reflected off one or more surrounding objects in the surroundings of the computer system 10, are scattered back to a receiver of the LiDAR system. The photons that come back to the receiver are collected with a telescope and counted as a function of time. Using the speed of light (˜3×10⁸ m/s), the processor 110 of the computing unit 100 of the computer system 10 can then calculate how far the photons have traveled (in the round trip). Photons can be scattered back off of many different entities surrounding the computer system 10.

In a specific non-limiting example, the LiDAR system can be implemented as the LiDAR based sensor that may be of the type available from VELODYNE LIDAR, INC. of 5521 Hellyer Avenue, San Jose, CA 95138, United States of America. It should be expressly understood that the LiDAR system can be implemented in any other suitable equipment.

Other implementations of the imaging system 18 enabling generating perception data 216 representing a driving scene that may be encoded into a graph representation, and other suitable devices are envisioned without departing from the scope of the present technology.

Thus, by using one of the approaches non-exhaustively described above, the imaging system 18 can be configured to generate perception data 216 representative of surrounding objects of the computer system 10. For example, in those embodiments where the computer system 10 is utilized outdoors, such objects can include, without limitation, particles (aerosols or molecules) of water, dust, or smoke in the atmosphere, moving and stationary surrounding objects of various object classes. In this example, object classes of the moving surrounding objects can include, without limitation, vehicles, trains, cyclists, pedestrians or animals. By contrast, object classes of the stationary objects can include, without limitation, trees, fire hydrants, road posts, streetlamps, traffic lights, and the like.

According to certain non-limiting embodiments of the present technology, the computer system 10 may comprise a memory 12 communicatively connected to the computing unit 100 and configured to store without limitation raw data captured by the imaging system 18, a High Definition (HD) map 212 (see FIG. 2) and the trained trajectory prediction model 24. The memory 12 may be embedded in the computer system 10. The computing unit 100 may be configured to access a content of the memory 12 via a network (not shown) such as a Local Area Network (LAN) and/or a wireless connexion such as a Wireless Local Area Network (WLAN).

The computer system 10 may also include a power system (not depicted) for powering its components. The power system may include a power management system, one or more power sources (e.g., battery, alternating current (AC)), a recharging system, a power failure detection circuit, a power converter or inverter and any other components associated with the generation, management and distribution of power in mobile or non-mobile devices.

Summarily, it is contemplated that the computer system 10 may perform at least some of the operations and steps of methods described in the present disclosure. More specifically, the computer system 10 may be suitable for generating a graph representation of agents and lanes in a driving scene and to process the graph representation with a heterogenous Graph Neural Network (GNN) to predict presence of template meta paths and agent trajectories. The incorporation of meta path prediction into the GNN (or other trajectory prediction model) allows for enhanced long-range connectivity of lane nodes. For example, in some non-limiting embodiments of the present technology, the computer system 10 can be part of a control system of an autonomous vehicle (also known as a “self-driving car”, not depicted in FIG. 1) and generate the graph structure representative of surrounding objects of the autonomous vehicle. In these embodiments, based on the graph structure and the trajectory prediction model, the processor 110 of the computer system 10 can be configured, for example, to generate a trajectory prediction for the autonomous vehicle and other agents.

Further, according to certain non-limiting embodiments of the present technology, the computer system 10 can be communicatively connected (e.g. via any wired or wireless communication link including, for example, 4G, LTE, Wi-Fi, or any other suitable connection) to a server 23.

In some embodiments of the present technology, the server 23 is implemented as a computer server and could thus include some or all of the components of the computing unit 100 of FIG. 1. In one non-limiting example, the server 23 is implemented as a Dell™ PowerEdge™ Server running the Microsoft™ Windows Server™ operating system, but can also be implemented in any other suitable hardware, software, and/or firmware, or a combination thereof. In some non-limiting embodiments of the present technology, the server 23 can be a single server. In alternative non-limiting embodiments of the present technology, the functionality of the server 23 may be distributed and may be implemented via multiple servers. The server 23 can be configured to execute some or all of the steps of the present methods.

With reference to FIG. 2, there is depicted a schematic diagram of an autonomous driving system 200 associated with a vehicle 210. The vehicle can be a car, a truck, a motorcycle, a van, a bus or any other kind of vehicle. Functionality described in the following relating to the autonomous driving system 200 may be executed by the computer system 10 of FIG. 1, which may be located at least partly on-board the vehicle 210. In the exemplary embodiment of FIG. 2, the autonomous driving system 200 includes a perception module 202, a prediction module 204, a planning module 206 and a control module 208.

The perception module 204 of the autonomous driving system 200 may be responsible for gathering information about the surrounding environment and determining the position and orientation (localization) of the vehicle 210. The perception module 202 utilizes a combination of sensors, such as cameras, LiDAR, radar, and any other imaging modalities of the imaging system 18 (see FIG. 1) and GPS, to perceive and understand the world around the vehicle 210. The perception module 202 processes the sensor data to identify and track objects, such as pedestrians, vehicles, cyclists and obstacles. Moving objects in a driving scene including vehicles, cyclists and pedestrians may be referred to as agents herein. The perception module 202 may use techniques like object detection, segmentation, and classification to create a comprehensive understanding of the driving scene. The perception module 202 includes a localization component, which may use sensor fusion algorithms to combine data from multiple sensors to determine the position and heading and other dynamics data relative to a global or local coordinate system. The perception module 204 aims to provide a real-time and high-fidelity representation of the surrounding environment, enabling subsequent modules to make informed decisions and plan trajectories.

The prediction module 204 of the autonomous driving system 200 may be responsible for forecasting the future behavior of dynamic objects (agents), including other vehicles, pedestrians, and cyclists, within the driving environment. This module leverages perception data 216 from the perception module 202 to predict likely trajectories of surrounding objects over a short-term and long-term horizon.

Using various techniques like machine learning, probabilistic modeling, and recurrent neural networks, the prediction module 204 considers the current state of surrounding objects and their interactions with the environment to estimate future movements of agents in the driving scene. As will be described further herein, the prediction module 204 generates a graph structure representation of the driving scene based on the perception data 216 from the perception module 202 that encodes map information from a HD map 212 and agent information from the perception module 202. The prediction module 204 includes a trajectory prediction model 44 that processes the graph to generate map compliant trajectories for agents in the driving scene. The predictions provided by the prediction module 202 are utilized for subsequent planning and control stages, as they enable the vehicle 210 (the ego vehicle) to anticipate the future behavior of other road users and make driving decisions based thereon.

The planning module 206 of the autonomous driving system 200 may be responsible for generating a high-level path and a corresponding motion plan for the vehicle 210 to reach a destination while avoiding obstacles and adhering to traffic rules. This module uses the perception data 216, localization information, and trajectory prediction data 218 from the previous modules to make informed decisions. The planning module 206 employs algorithms to search for an optimal or near-optimal path from the current location to the destination. The planning module 208 considers factors such as road constraints, traffic regulations, predicted object movements, and environmental conditions to determine a route. Once the path is determined, the planning module 206 generates a motion plan, embodied in motion plan data 220, that translates the high-level path into a series of feasible vehicle movements, including acceleration, braking, and steering commands.

The control module 208 of the autonomous driving system 200 may be responsible for executing the motion plan generated by the planning module 206 to drive the vehicle. The control module 208 receives real-time feedback from various vehicle sensors, such as wheel encoders and inertial measurement units (IMUs), to monitor the current state of the vehicle 210 and make necessary adjustments to follow the planned trajectory accurately. Using techniques like model predictive control (MPC), proportional-integral-derivative (PID) control, or reinforcement learning, the control module 208 continuously adjusts the steering, throttle, and brake inputs of the vehicle 210 by providing actuator control data 222 to an actuator system 224 of the vehicle 210 for executing braking, steering and throttle actuators of the vehicle 210 to maintain the desired trajectory and velocity.

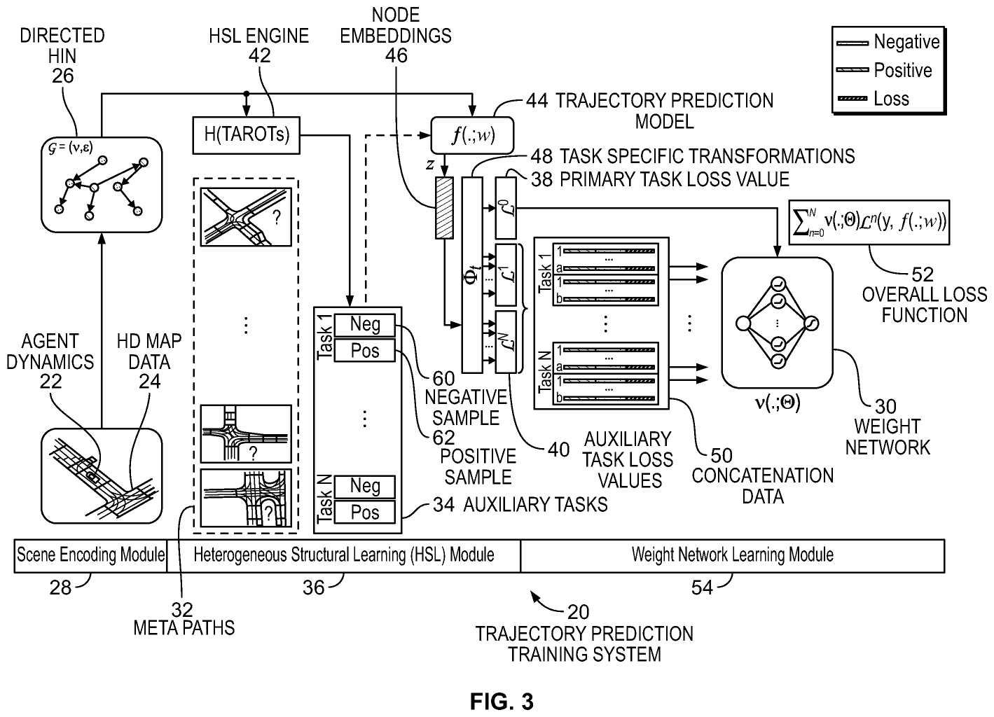

With reference to FIG. 3, there is depicted a schematic diagram of a trajectory prediction training system 20 for training the trajectory prediction model 44 used by the prediction module 204, in accordance with certain non-limiting embodiments of the present technology. The trajectory prediction training system 20 includes a scene encoding module 28, a heterogenous structural learning (HSL) module 36 and a weight network learning module 54. Each of these modules are executed by a computing system 10 as illustrated in FIG. 1, particularly by the processor 110 executing computer program instructions as has been described heretofore.

The scene encoding module 28 receives HD map data 24 and agent dynamics data 22 as part of the perception data 216 from the perception module 202. Lane and road features can be extracted from the HD map data 24 and the geographic extent thereof can be provided as points, polygons or curves in geographic coordinates. For example, a lane boundary contains multiple control points that build a spline; a cross-walk is a polygon defined by several points; a stop sign is represented by a single point. Such geographic entities extracted from the HD map data 24 are approximated as polylines defined by control points along with associated attributes (e.g. type labels such as lane boundaries, lane centerline, traffic sign, etc.). Dynamics of moving agents may also be approximated by polylines based on historic motion trajectories over a set time window. The polylines of agents and lanes are represented as a set of vectors.

Annotations from the HD map 212 (see FIG. 2) may be in the form of splines (e.g. lanes), closed shape (e.g. regions of inter-sections) and points (e.g. traffic lights), with additional attribute information such as the semantic labels of the annotations and their current states (e.g. color of the traffic light, speed limit of the road). For agents, their trajectories are in the form of directed splines with respect to time. For example, agent trajectories may be represented as a sequence of displacements in time steps over a past time window of a given size from current time. All of these elements can be approximated as sequences of vectors: for map features, the scene encoding module 28 takes a starting point and direction, uniformly sample key points from the splines at the same spatial distance, and sequentially connects the neighboring key points into vectors; for trajectories, the scene encoding module 28 samples key points with a fixed temporal interval (e.g. 0.1 second), starting from t=0, and connects them into vectors. Given small enough spatial or temporal intervals, the resulting polylines serve as close approximations of the original map and trajectories. The creation of vector data for agent and map data is a vectorization process that facilitates creation of a graph representation. More specifically, each vector belonging to a polyline is represented as a node in a graph with node features given by start and end coordinates of the start and end points of the vector, attribute features, such as object type, timestamps for trajectories, or road feature type or speed limit for lanes, and node ID.

Continuing to refer to FIG. 3, the agent dynamics data 22 and the HD map data 24 is formulated into a directed Heterogenous Information Network (HIN) 26. A directed HIN 26 is a graph data structure including edges between nodes. Unlike an undirected HIN, the edges have a specific direction associated with them, which supports understanding of lane directions from the HD map data 24. The edges of the directed HIN 26 have an inherent orientation, meaning they point from one node to another, indicating a unidirectional relationship between the nodes. The directed HIN 26 may be defined as a graph [symbol] =( [symbol] , [symbol] ) where [symbol] is the set of nodes and [symbol] is the set of edges, each representing a binary relation between two nodes in [symbol] . [symbol] is associated with two mappings: (1) node type mapping function ϕ: [symbol] → [symbol] and (2) edge type mapping function Ψ: [symbol] → [symbol] , where [symbol] and [symbol] denote sets of node and edge types, respectively. If | [symbol] +| [symbol] >2, network [symbol] is an HIN, otherwise it is homogeneous.

A driving scene embodied by the HD map data 24 and the agent dynamics data 22 is encoded as the directed HIN 26 with node types [symbol] ={lane,agent} and [symbol] ={left, right, successor, predecessor} as basic relations between adjacent lanes. To initialize node features in the directed HIN 26, PointNet may be used in one embodiment with Multi-Layer Perceptrons (MLP) to process polyline features and a 1D convolution with a feature pyramid network to process agents' observations. PointNet can be used to process individual nodes' features as point clouds to obtain node embeddings. The node features can be considered as 3D points, and PointNet can be applied to process these points and generate embeddings for each node. The use of PointNet and the 1D convolution with a feature pyramid network to process the directed HIN 26 is provided by way of example. However, other machine learning engines may be utilized. For example, Graph Convolutional Networks (GCNs) may be used to process the directed HIN 26, as can Graph Attention Networks (GAT), Graph Transformers, combinations thereof and other Graph Neural Networks (GNNs). Any type of GNN can be used to process the directed HIN 26. In one embodiment, a Heterogeneous Graph Transformer (HGT) is used to process the directed HIN 26, which is a deep learning model.

Whichever model is used to process the directed HIN 26, this model is trained according to the trajectory prediction training system 20 described further herein and, once trained, forms the trajectory prediction model 44 at run-time. As a result of processing the directed HIN 26, all information flows between agent and lane nodes may be captured including actors to lanes (a2l), lanes to lanes (l2l), lanes to agents (l2a) and agents to agents (a2a), or combinations of at least two thereof. Agents to lanes introduces real-time traffic information to lane nodes. Lanes to lanes updates lane node features by propagating traffic information over the lane graph. Lanes to agents fuses updated map features with real-time traffic information back to the agents. Agents to agents handle interactions between agents and produces output agent features which may be used by a prediction header for motion forecasting. As such, the processed directed HIN 26 may include the following types of edges—successor, predecessor, left, right, agents to lanes, lanes to lanes, lanes to agents and agents to agents.

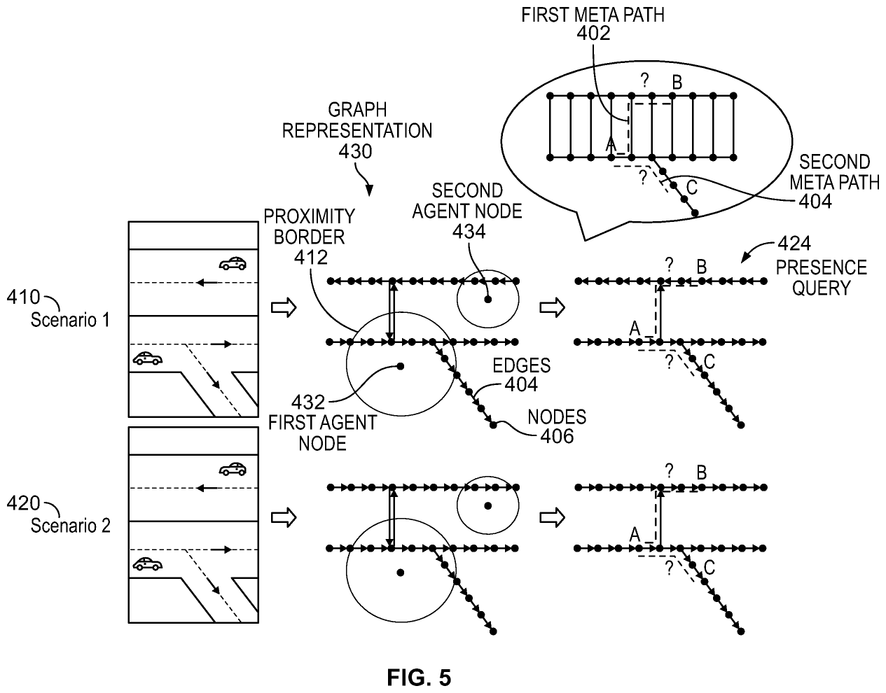

The trajectory prediction training system 20 includes a HSL engine 42, which is provided with the directed HIN 26 G of a driving scene and is also provided with N predefined meta paths 32. The HSL engine 42 defines N HSL tasks (auxiliary tasks 24) each predicting the presence (negative or positive) of each of the meta paths 32 between a pair of nodes. For each meta path 32, positive samples 62 are two arbitrary nodes from the directed HIN 26 that can be reached by the meta path task, and negative samples 60 are those that cannot, which will be described further with respect to FIG. 5. For the HSL tasks (the auxiliary tasks 34) and the primary task (agent trajectory prediction), learned representations Z (node embeddings 46) from GNN model (trajectory prediction model 44) f are used to make respective predictions. To find the loss values (auxiliary task loss values 40), positive and negative samples 60, 62 are fed through the task-specific transformations Φₜ (task specific transformations 48) followed by task-specific loss functions to determine loss values (primary task loss value 38 and auxiliary task loss values 40) based on a comparison between trajectory prediction ground truth (provided by training data labelling) and meta path ground truth (provided by algorithmic interrogation of the directed HIN 26). By providing loss values of the primary task samples and the HSL task samples (as a concatenation of [task id, label (Pos/Neg), loss value]−concatenation data 50), the weight network learning module 54 learns a weight function (or weight network 30) in a way to find an optimal combination of the HSL tasks in a meta learning manner. The weight network 30 defines how much weight should be given to each type of meta path 32 whilst maintaining the overriding objective of accuracy of the primary trajectory prediction task.

The meta paths 32 are representative of common lane transitions that may be made by an agent in a driving scene. The meta paths 32 are predefined, template connections between more than two successively connected lane nodes. The meta paths 32 may have a length of between 3 and 7 successively connected lane nodes, for example. The meta paths 32 may include at least one left or right transition or a combination of left and right transitions. The HSL engine 42 may have a stock of at least 5 different types of meta paths 32 that are each processed during training and run-time of a given driving scene.

In FIG. 3, three different types of meta paths 32 are shown by way of example. A right turn included in five successively connected nodes (defined as successor, successor, right, successor, successor), another type of right turn (successor, right, successor, successor, successor) and a U-turn (defined as successor, right, right, successor, successor). Other common road transitions that may be connected include left turns, lane merging, lane changing, etc. Within a defined local proximity of each agent (which may be a speed variable limit number of nodes), the HSL engine 42 takes a starting node within the local proximity and an arbitrarily selected end node that is a distance away of a length of the meta paths 32 (e.g. 5 nodes distant) within the directed HIN 26. The HSL engine 42 is able to automatically (algorithmically) label whether the start and end nodes may be reached by a given one of the meta paths 32 by interrogating the directed HIN 26. Any graph traversal algorithms may be used to determine whether two nodes are connected, such as Breadth-First Search (BFS) or Depth-First Search (DFS). Using a graph traversal algorithm, the directed HIN 26 may be efficiently explored and a determination can be made whether there exists a valid path connecting two nodes. The algorithm will take advantage of the directed edges to ensure that only valid paths (conforming to the edge directions) are considered during the traversal process. The HSL engine 42 thus provides, and labels, a positive sample 62 of two nodes that are connected within the directed HIN 26 by the meta path 32 and a negative sample 60 that cannot be connected within the directed HIN 26, thereby providing a positive sample 62 of a map compliant road transition modelled by the meta path and a non-compliant road transition as a negative sample 60. Positive and negative samples 60, 62 between two nodes are provided for each meta path 32 and each agent in the driving scene.

The concept of a meta path 32 is further described with reference to FIG. 5, which provides an example of positive and negative presence of a meta path between nodes. A graph representation 430 of a first driving scene 410 and a second driving scene 420 is schematically depicted by way of example. The graph representation 430 includes lane nodes 406 and directional edges 404 embodying a map compliant direction of travel between adjacent lane nodes 406. The graph representation 430 includes first and second agent nodes 432, 434 representing respective agents, which in this case are vehicles. The HSL engine 42 may determine a speed variable proximity border 412 around each agent. The HSL engine 42 may select one of the lane nodes 406 within that proximity border 412 as a start node and select another node that is a length (number of lane nodes) of a given meta path away from the start node as an end node. The end node should be outside of the proximity border 412.

In the example of FIG. 5, the start node is taken as node A and possible end nodes are taken as nodes B and C. Two exemplary meta paths 402, 404 are illustrated each having a length of four lane nodes. The first meta path 402 includes the following pattern of edges-successor, left, successor, successor (SLSS). The second meta path 404 includes the following pattern of edges-successor, successor, right, successor (SSRS). In the first driving scenario 410, the HSL engine can query (presence query 424) the directed HIN 26 as to whether there is a valid first meta path 404 between nodes A and B and between nodes A and C. Neither of these options have a valid path and thus the paths A to B and A to C will be labelled by the HSL engine 42 as negative with respect to presence of the first meta path 402. The second meta path 404 is negative for nodes A to B but positive for nodes A to C and the HSL engine 42 will provide negative and positive labels accordingly. In the second driving scenario 420, the first meta path 402 SLSS is possible as there is compliant traffic direction (which is encoded in the directed HIN 26) in the second driving scenario 420 unlike the first driving scenario 410. The presence query 424 will return a positive label for nodes A to B and a negative label for the nodes A to C with respect to the first meta path 402. The presence query 424 will return a negative label for nodes A to B and a positive label for the nodes A to C with respect to the second meta path 404. Referring back to FIG. 3, the HSL engine 42 provides a pair of positive and negative samples for each of the meta paths 32 and for each agent in the driving scene as respective auxiliary tasks 34 (one task for each meta path comprising positive and negative samples that have been automatically labelled through a graph traversal algorithm).

Referring again to FIG. 3, the HSL engine 42 organizes a set of auxiliary tasks 34 for each meta path 32 that serve as link prediction operations for the trajectory prediction model 44. Specifically, node embeddings 46 are obtained from the trajectory prediction model 44 and used as the basis for link prediction for the negative and positive samples 60, 62 for each link prediction task. The link prediction operation is one of predicting, using the node embeddings 46, whether the nodes of each sample and each auxiliary task 34 are validly connected by the meta path 32. If so, a positive prediction is made and otherwise a negative prediction is made. The predictions from the trajectory prediction model 44 regarding the auxiliary tasks 34 are compared with the algorithmically labelled samples to determine auxiliary task loss values 40 used in training the trajectory prediction model 44.

Continuing to refer to FIG. 3, the HSL module 36 will be described in further detail. Traffic transitions follow patterns governed by high-level constraints stemming from long-range structural connections between lanes of the road. For learning the map structure of the HD map data 24, heterogeneity helps interpret a series of relations, which the trajectory prediction model 44 learns with meta paths 32 (which are road or lane paths). A meta-path

$$𝒫 = {v}_{1} {\to }^{{r}_{1}} {v}_{2} {\to }^{{r}_{2}} … {\to }^{{r}_{ℓ}} {v}_{ℓ + 1}$$

expresses a compositie relation R=r₁∘r₂ . . . ∘r₁ between nodes v₁ and v₁₊₁, where ∘ denotes the composition operator on relations. If two nodes vᵢ and vⱼ are related by the composite relation R, then there exists a path that connects vᵢ to vⱼ in [symbol] , denoted by [symbol] . Moreover, the nodes and edges types in [symbol] match with types in [symbol] and [symbol] , respectively. The features obtained from the meta-path analysis in the directed HIN 26 are notably useful in improving graph-based models since they encode indirect semantic relations between nodes that are not directly connected. These features also aid in establishing new relations between vertices. As such, the meta-path analysis described herein can enhance graph representation learning power and improve downstream tasks, such as node classification and link prediction. This means meta-paths can help find new patterns and relations in the directed HIN 26. By focusing on the long-range relations that impose transitions on the road, the meta paths 32 p though the directed HIN 26 may be defined as a path instance of p_{vi˜vj}├ [symbol]
where node types are the same (specifically lane nodes). Thus, a meta path 32 can formulate a combination of basic road relations corresponding to transition patterns imposed by map constraints of the HD map data 24.

The HSL engine 42 orchestrates predicting the presence (positive or negative) of a meta path between two nodes vᵢ and vⱼ as a link prediction task using node embeddings 46 obtained from the trajectory prediction model 44 (which may be a GNN). Here, the link means heterogeneous composite relations between nodes. Contrary to link prediction problems, the meta path prediction can be treated as a self-supervised task. In detail, a rule is followed to provide the additional supervised signals for the auxiliary tasks 34: If node [symbol] is reachable from node [symbol] by TAROT p, then [symbol] =1, otherwise [symbol] =0. This means the HSL task, associated with the meta paths 32, will be formed as a link prediction task without the need for any additional data or manual labeling. Hence, by obtaining the hidden representations of two arbitrary nodes learned by a GNN (the trajectory prediction model 44) and using an operator [symbol] =σ(Φₜ(zᵤ)^{T}Φₜ(zᵥ)), it is possible to predict whether a meta path 32 between two nodes is present or absent. Here, Φₜ is a task-specific transformation 48 t∈ [symbol] and zᵤ and zᵥ are the node embeddings 46 of nodes u and v. The meta paths 32 model common patterns of driving that adhere to the map constraints. Hence, several (e.g. between 4 and 7) meta paths 32 are formulated that represent different diverse traffic patterns within the driving scene, resulting in several HSL auxiliary tasks 34 that can be used to predict diverse and admissible trajectories.

The HSL module 36 is configured to identify diverse patterns within the road structure, for which various meta paths 32 form the basis of exploration of the directed HIN 26 resulting in several self-supervised HSL auxiliary tasks 34 to be learned simultaneously with the trajectory prediction primary task. The HSL auxiliary tasks 34 are chosen and properly weighted so that learning the map structure does not compete with the primary task of trajectory prediction, especially since the capacity of the GNN (the trajectory prediction model 44) is limited. To this end, the weight network learning module 54 is provided, which is a learning framework for trajectory prediction that offers the possibility of learning to learn the road configuration while learning the primary task of trajectory prediction. In one embodiment, the weight network learning module 54 performs a naive multi-task combination of self-supervision tasks with a meta-learning objective. An example of one way of learning the weight network 30 is provided in the following. It should be understood that other manners of learning the relative weights of each meta path auxiliary task 34 can be implemented to support training the trajectory prediction model 44 with long range node connectivity learned through use of the meta paths 32.

In one embodiment, a naive multi-task combination of the HSL auxiliary tasks 34 is incorporated. The weight network learning module 54 adopts a combination of Self-Supervised Learning (SSL) tasks, namely auxiliary tasks 34, to improve the primary task of trajectory prediction. The naive multi-task combination of HSL tasks, as SSL tasks, provides a shared backbone network with parameters w, between the primary and all auxiliary (or proxy) tasks 34. Each task has a specific loss function [symbol] (embodied by primary task loss value 38 and auxiliary task loss values 40) incorporated by a task-specific parameter λₙ. So, the optimal parameter w* can be extracted by the following objective function:

$$\begin{matrix}n = 0 n {\vert}_{1}^{N} {n}^{th} {N}^{m i {n}_{w}} \\ 𝔼 [ {λ}_{0} {ℒ}^{0} ( . ; w ) + {\sum }_{n = 1}^{N} {λ}_{n} {ℒ}^{n} ( . ; w ) ]\end{matrix} \qquad ( 1 )$$

n=0n|₁^{N}n^{th}N where index zero stands for the primary task, and index denotes task of auxiliary tasks 34.

The weight network learning module 54 has a meta-learning objective to learn road topology that enhances rather than competes with trajectory prediction. As such, the weight network learning module is configured to determine an effective combination of λ parameters. To achieve this, the weight network learning module 54 parameterizes the model w(Θ) to determine an optimal combination of HSL auxiliary tasks 34 and automatically balances them for improved prediction as shown below:

$$\begin{matrix}{min}_{w , Θ} \\ 𝔼 [ {ℒ}^{0} ( w * ( Θ ) ) ] \\ s . t . \\ w * ( Θ ) = {arg min}_{w} \\ 𝔼 [ {ℒ}^{n {\vert}_{0}^{N}} ( w ; Θ ) ] .\end{matrix} \qquad ( 2 )$$

Specifically, to parametrize the model parameters w, a learnable weighting function, which is the weight network 30 in FIG. 3, [symbol] (⋅, Θ) is integrated into the objective function in equation (1). Thus, the objective function can be written as follows:

$$w * ( Θ ) = {arg min}_{w} {\sum }_{n = 0}^{N} {\sum }_{i = 1}^{{M}_{n}} \frac{1}{{M}_{n}} 𝒱 ( {Ψ}_{i}^{n} ; Θ ) {ℒ}^{n} ( {y}_{i}^{n} , {f}^{n} ( {x}_{i}^{n} ; w ) ) \qquad ( 3 )$$

where each task has Mₙ samples (positive and negative samples 60, 62) and fⁿ is the model for task n. For i^{th} sample of task n, yᵢⁿ is the label provided by the HSL engine 42 using a graph traversal function as described above, and Ψᵢⁿ is an embedding vector expressed as the concatenation of one-hot vector of task types, the label (positive/negative), and the loss value of the sample. Equation (3) includes the overall loss function 52 shown in FIG. 3. Following equation (3), the model learns how to assist the primary task by optimizing the parameters Θ. These parameters can be optimized using a meta-learning approach.

According to the meta-learning approach, a small amount of meta-data D^{meta}, representing the meta-knowledge of ground-truth D^{gt}, D^{meta}∪D^{train}=D^{gt}, the optimal parameter Θ* can be obtained by minimizing the following loss:

$${Θ}^{*} = {arg min}_{Θ} {ℒ}^{meta} ( w * ( Θ ) ) {=}^{△} \frac{1}{m} {\sum }_{i = 1}^{m} {ℒ}_{i}^{meta} ( w * ( Θ ) ) \qquad ( 4 )$$

where m and r, m<<r, are the number of meta-samples and training samples, respectively, and meta-loss is:

$$\begin{matrix}{ℒ}_{i}^{meta} ( w ) = ℒ ( {y}_{i}^{meta} , f ( {x}_{i}^{meta} , w ) ) \\ where \\ ( x , y ) ∼ {D}^{meta} .\end{matrix} \qquad ( 5 )$$

To overcome the complexity of the bi-level optimization, an online strategy is used to approximate w* and Θ* with the updated parameters ŵ and \hat{Θ}, respectively through a single optimization loop. In each iteration of training, given training data D^{train}, HSL auxiliary tasks 34 data D^{hsl}, and meta-data D^{meta}, three steps may be followed.

First, a model parameter is formulated. An updating equation of model parameter w is formulated by moving the current w^{t} along the descent direction of the loss in Equation (3),

$${{\hat{w}}^{( t )} ( Θ )}_{{D}^{train} ⋃ {D}^{hsl}} = {w}^{( t )} - α \frac{1}{N} {\sum }_{n = 0}^{N} 𝒱 ( \cdot ; Θ ) {∇}_{w} {ℒ}^{n} ( w ) {\vert}_{{w}^{( t )}} \qquad ( 6 )$$

where α is the learning rate for w and [symbol] denotes the loss function for the task number n. To avoid cluttered notation, the summation of task samples is omitted.

Second, the parameters are updated. After updating model parameter [symbol] (Θ), parameter Θ can be updated guided by Equation (4), i.e., moving the current parameter Θ^{(t)} along the objective gradient of Equation (4) calculated on the meta-data,

$${{Θ}^{( t + 1 )}}_{{D}^{meta}} = {Θ}^{( t )} - β𝒱 ( \cdot ; Θ ) {ℒ}^{0} ( {\hat{w}}^{( t )} ( Θ ) ) {\vert}_{{Θ}^{( t )}} \qquad ( 7 )$$

where β is the learning rate for Θ. This update allows the soft selection of useful HSL auxiliary tasks 34 and balances them with the main motion prediction task to improve the performance of the main task. Without balancing tasks with the weighting function [symbol] (·; Θ), auxiliary tasks 34 can dominate training and degrade the performance of the primary task.

Third, the model parameters are updated. Model parameters w for tasks can be updated with optimized Θ^{t+1} in Equation (7) as,

$${{\hat{w}}^{( t + 1 )} ( Θ )}_{{D}^{train} ⋃ {D}^{hsl}} = {w}^{( t )} - α \frac{1}{N} {\sum }_{n = 1}^{N} 𝒱 ( \cdot ; {Θ}^{( t + 1 )} ) {∇}_{w} {ℒ}^{n} ( w ) {\vert}_{{w}^{( t )}} . \qquad ( 8 )$$

Lastly, to circumvent the problem of meta-overfitting, meaning that parameters Θ overfit to the small meta-dataset, Θ is made generalizable across meta-training sets and is optimized using K different meta-datasets with k-fold cross-validation. The gradients of Θ from different meta-datasets are then averaged to update Θ^{(t)}.

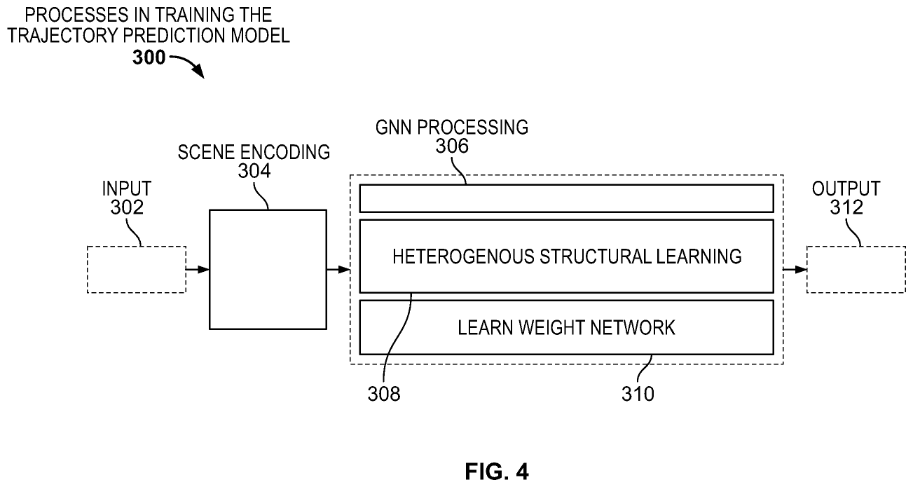

FIG. 4 depicts processes 300 in training the trajectory prediction model 44. The processes 300 are executed by the processor 110 of the computer system 10 of FIG. 1. With additional reference to FIG. 3, as inputs 302 to a step of scene encoding 304, there are agent trajectories in the form of agent dynamics data 22 and road elements in the form of HD map data 24. The agent trajectories includes various dynamics data including position at a sequence of time steps over a historical time window, heading, etc. The road elements define lane boundaries, lane centerlines and permitted direction of travel, amongst other road data. In the step of scene encoding, a heterogeneous scene graph is created based on the agent dynamics data and the HD map data 24 while adopting a dynamic threshold for graph connectivity, thereby forming the directed HIN 26. The directed HIN 26 is created to include a plurality of node types {agent, lane} and a plurality of edge types {a2a, a2l, l2a, left, right, predecessor, successor}. A node type mapping function is used to initialize node features.

In step 306 of GNN processing, a hheterogeneous graph neural network (HGNN) is adopted to embed rich structural and semantic information of a heterogeneous graph into node representations by processing the directed HIN 26.

In step 308 of Heterogeneous Structural Learning (HSL), a map structure is learned in the scene graph using structural graph characteristics. A meta-path 32 (composite relations of multiple edge types including at least different types of successor, left, right, predecessor) is employed as a structural graph characteristic. A meta-path prediction (link prediction) is defined as an auxiliary task 34 of HSL and the ground truth label for the predicted outcome of the auxiliary task 34 is provided algorithmically by a graph traversal function on the directed HIN 26. This will result in an auxiliary task loss value 40 for use in optimizing the weight network 30. A plurality of meta paths 32 are employed in this way for each agent in a driving scene being processed starting at a lane node location proximal to the agent and extending a length of the meta path away from the start node to an arbitrarily selected end node. Positive and negative samples 60, 62 for each meta path 32 and each agent are selected with associated algorithmically determined ground truth data being compared to corresponding predictions from the trajectory prediction model 44 to determine a set of auxiliary task loss values 40. There is no need for manual labeling (add a new link, if node B is reachable from node A by a specific meta-path 32), resulting in a fully self-supervised learning approach.

In step 310, the weight network 30 is learned based on the auxiliary task loss values 40 and a primary task loss value 38. The primary task loss value 38 is obtained by comparing labelled trajectory predictions for each agent in training data and corresponding predictions by the trajectory prediction model 44. The weight network 30 is learned under a learning to learn paradigm whereby multiple map-related tasks (auxiliary tasks 34) are learned simultaneously to provide different semantic aspects of a map to boost performance on the primary task. An effective combination of auxiliary tasks 34 are identified and automatically balanced to improve the primary task by using the meta-learning idea to learn a weight function (the weight network 30). In learning the weight network 40 in step 310, the overall loss function 52 receives the primary task loss value 38 and the auxiliary task loss values 40 and adapts the weight function parameter to minimize the objective function, which includes the overall loss function 52, as discussed in the foregoing.

In output step 312, at least one predicted trajectory for each agent is provided (along with optional confidence scores) and predictions for each auxiliary task 34 is output.

Described herein are systems and methods for training a trajectory prediction model and the trajectory prediction model so trained. The systems and methods context encode agents' dynamics along with high-dimensional map information, which are then processed to produce a directed HIN. Given the directed HIN, a HSL engine designs a set of HSL tasks to capture relations between lanes. An explicit weighting function is learned to softly select HSL tasks and balance them to improve the performance of the primary task of trajectory prediction via meta-learning.

The systems and methods described herein provide for Heterogeneous Structural Learning (HSL) that models long-range connectivity within the map using structural graph characteristics, thus embedding existing constraints in the map. There is no requirement for manual labeling or extra data, allowing for self-supervised learning. Features of Learning to Learn Paradigm enable the model to identify an effective combination of proxy tasks and automatically balance them to improve the primary task and offer the possibility of exploiting any map-related task in order to provide numerous aspects of road semantics. The systems and methods are computationally efficient. By defining various self-supervised tasks and learning with the same architecture, it is possible to maintain the complexity level of any baseline compared to recent state-of-the-art models with high complexity. Further, there is no overhead on inference time in our proposal, only on training time. The presently disclosed framework can be applied to any graph-based map encoder (either homogeneous or heterogeneous) in a plug-in manner without manual labeling or additional data. Learning multiple tasks simultaneously while using the same architecture can potentially increase generalizability and robustness. Long-range connectivity modeling as described herein allows understanding of road topology resulting in scene-compliant trajectory prediction.

Although the present disclosure is described primarily in terms of autonomous vehicles, it should be understood that the systems and methods can be applied in any other other field that needs to learn about its surroundings, like surveillance, assistive robotics, and surveying.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computerized method of training a trajectory prediction model for autonomous driving vehicles, the method comprising:
receiving agent dynamics data;
receiving high-dimensional (HD) map data;
performing scene encoding on the agent dynamics data and the HD map data to produce a directed Heterogeneous Information Network (HIN) as a graph comprising nodes and edges, wherein there is a plurality of node types including lane nodes and agent nodes and a plurality of edge types;
receiving a plurality of meta paths through the directed HIN representing lane transitions, each meta path comprising a sequence of lane nodes and edges;
receiving a training data set;
training the trajectory prediction model based on a comparison between a prediction, by the trajectory prediction model, of a positive or negative presence of the meta paths between nodes and meta path ground truth obtained from the training data set and between motion trajectory predictions, by the trajectory prediction model, and motion trajectory ground truth obtained from the training data set; and
storing the trajectory prediction model on computer memory for use in trajectory prediction for autonomous vehicles.

2. The computerized method of claim 1, wherein the trajectory prediction model is a Graph Neural Network.

3. The computerized method of claim 1, wherein training the trajectory prediction model comprises meta path self-supervised learning having trajectory prediction as a primary task and predicting presence of meta paths between nodes as auxiliary tasks.

4. The computerized method of claim 3, wherein the primary task and the auxiliary tasks share model parameters and each of the primary and auxiliary tasks have a task specific parameter in an objective function that is minimized in training the trajectory prediction model.

5. The computerized method of claim 4, comprising parametrizing the model parameters using a weighting function that is learned during training.

6. The computerize method of claim 1, wherein the comparison between the prediction, by the trajectory prediction model, of the positive or negative presence of the meta paths between nodes and the meta path ground truth obtained from the training data set and between the motion trajectory predictions, by the trajectory prediction model, and the motion trajectory ground truth from the training data set comprises calculating loss values for each of the plurality of meta paths and for the motion trajectory predictions.

7. The computerized method of claim 1, wherein the edge types comprise at least two of: agents to lanes, lanes to lanes, lanes to agents and agents to agents, successor node, predecessor node, left node and right node.

8. The computerized method of claim 1, wherein training the trajectory prediction model comprises predicting, by the trajectory prediction model, the positive or negative presence of the meta paths between a plurality of arbitrary nodes, wherein the meta path represents common driving lane transitions by agents.

9. The computerized method of claim 1, wherein predicting, by the trajectory prediction model, the positive or negative presence of the meta paths between nodes is performed as a link prediction task.

10. The computerized method of claim 1, wherein the meta path ground truth is, at least in part, algorithmically determined based by traversing the meta path between nodes in the directed HIN.

11. The computerized method of claim 1, wherein positive and negative samples are provided for each meta path during training the trajectory prediction model.

12. The computerized method of claim 1, wherein training the trajectory prediction model based on the comparison between the prediction, by the trajectory prediction model, of the positive or negative presence of the meta paths between nodes comprises selecting a start node within a local boundary of an agent and selecting an end nodes at a predefined number of successive nodes away from the agent and assessing the positive or negative presence of the meta paths against the start and end nodes.

13. The computerized method of claim 1, wherein the meta paths have a length of between 4 and 7 successive lane nodes and include at least one left or right transition.

14. The computerized method of claim 1, wherein the plurality of meta paths comprises at least 4 different meta paths.

15. A system comprising: at least one processor, and at least one memory comprising executable instructions that, when executed by the at least one processor, cause the system to:
receive agent dynamics data;
receive high-dimensional (HD) map data;
perform scene encoding on the agent dynamics data and the HD map data to produce a directed Heterogeneous Information Network (HIN) as a graph comprising nodes and edges, wherein there is a plurality of node types including lane nodes and agent nodes and a plurality of edge types;
receive a plurality of meta paths through the directed HIN representing lane transitions, each meta path comprising a sequence of lane nodes and edges;
receive a training data set;
train the trajectory prediction model based on a comparison between a prediction, by the trajectory prediction model, of a positive or negative presence of the meta paths between nodes and meta path ground truth obtained from the training data set and between motion trajectory predictions, by the trajectory prediction model, and motion trajectory ground truth obtained from the training data set; and
store the trajectory prediction model on computer memory for use in trajectory prediction for autonomous vehicles.

16. The system of claim 15, wherein the trajectory prediction model is a Graph Neural Network.

17. The system of claim 15, wherein training the trajectory prediction model comprises meta path self-supervised learning having trajectory prediction as a primary task and predicting presence of meta paths between nodes as auxiliary tasks.

18. The system of claim 17, wherein a weight network is trained during training the trajectory prediction model with weights for the auxiliary tasks learned with the objective of optimizing the primary task.

19. The system of claim 15, wherein predicting, by the trajectory prediction model, the positive or negative presence of the meta paths between nodes is performed as a link prediction task, and wherein the meta path ground truth is, at least in part, algorithmically determined by traversing the meta path between nodes in the HIN.

20. An autonomous vehicle, comprising:
a perception system for providing perception data of a driving scene;
a motion planning system, the motion planning system comprising:
at least one processor, and at least one memory comprising executable instructions that, when executed by the at least one processor, cause the motion planning system to:
determine agent dynamics data for agents in the driving scene based on the perception data;
retrieve high-dimensional (HD) map data;
perform scene encoding on the agent dynamics data and the HD map data to produce a directed Heterogeneous Information Network (HIN) as a graph comprising nodes and edges, wherein there is a plurality of node types including lane nodes and agent nodes and a plurality of edge types;
receive a plurality of meta paths through the directed HIN representing lane transitions, each meta path comprising a sequence of lane nodes and edges; and
processing the meta paths and the directed HIN using a trajectory prediction model to predict at least one trajectory for the agents in the driving scene; and
an autonomous vehicle driving system to control driving of the autonomous vehicle based on the at least one trajectory.
